(19) United States
(12) Patent Application Publication
(10) Pub. No.: US 2024/0037127 A1
(43) Pub. Date: Feb. 1, 2024

(54) STRUCTURED AND UNSTRUCTURED DATA COMPARISON WITH COMPLEX AND VARIABLE NATURAL LANGUAGE TEXT

(71) Applicant: Certificate Hero, Inc., Dedham, MA (US)

(72) Inventors: John Paul SUTRICH, Westwood, MA (US); Richard Kurt MYERS, Kissimmee, FL (US); Jake OCONNELL, North Reading, MA (US); Michael J. YANOFF, Westwood, MA (US)

(73) Assignee: Certificate Hero, Inc., Dedham, MA (US)

(21) Appl. No.: 18/226,842

(22) Filed: Jul. 27, 2023

Related U.S. Application Data
(60) Provisional application No. 63/392,807, filed on Jul. 27, 2022.

(51) Int. Cl. G06F 16/31

(52) U.S. Cl. CPC G06F 16/313

(57) ABSTRACT

Described herein are techniques that may be implemented by a computerized system for parsing contracts using natural language understanding and/or textual analytics rules and determining whether a party to a contract is compliant with insurance coverage identified by the contract. Some techniques described herein can create structured data from unstructured contract text describing insurance coverage that a party to a contract is required to hold. Some such techniques including comparing the structured data indicating required coverages (which was determined from the unstructured text) to other structured data indicating coverages held by a party, to determine whether the coverage held by the party satisfies the required coverages. In some embodiments, a system implementing these techniques output whether coverage is missing or otherwise insufficient, or whether the coverages held by a party satisfy required coverages of the contract.

### CROSS-REFERENCE TO RELATED APPLICATIONS

This application claims the benefit under 35 U.S.C. § 119(e) of U.S. Provisional Application No. 63/392,807, filed Jul. 27, 2022 and titled “Structured and unstructured data comparison with complex and variable natural language text,” the entire contents of which are incorporated herein by reference.

### BACKGROUND

Contracts between parties may specify responsibilities or obligations that a party is expected to meet to be compliant with the contract. In many cases, those responsibilities or obligations may relate to insurance coverage. For example, a contract may specify that a party is obligated to hold insurance of certain types and amounts, to protect against damages owed by one party to the contract or another in an event that liability arises due to some circumstance related to the contract.

### SUMMARY

In some aspects, the techniques described herein relate to a method including: creating structured data from unstructured text of a contract, wherein creating the structured data includes: analyzing the unstructured text of the contract to identify one or more parts of the contract that address insurance a party to the contract is required to hold; analyzing the one or more parts of the contract using a natural language understanding engine trained to identify required insurance coverages and/or at least one rule identifying structure of text relating to a required insurance coverage to identify one or more required insurance coverages that the party to the contract is required to hold, wherein analyzing the one or more parts of the contract to identify the one or more required insurance coverages includes determining from the unstructured text, for each required insurance coverage of the one or more required insurance coverages, a line of business to which the required insurance coverage relates and one or more attributes of the required insurance coverage for the line of business; retrieving, from at least one data store, structured data indicating one or more insurance coverages identified for the party to the contract, the structured data identifying for each insurance coverage of the one or more insurance coverages a line of business to which the insurance coverage relates and one or more attributes of the insurance coverage; determining whether the one or more insurance coverages identified for the party satisfy the one or more required insurance coverages that the party to the insurance contract is required to hold, wherein determining whether the one or more insurance coverages satisfy the one or more required insurance coverages includes in response to determining that an insurance coverage for a line of business, of the one or more insurance coverages identified for the party, corresponds to a required insurance coverage for the line of business, comparing one or more required attributes of the required insurance coverage to one or more attributes of the insurance coverage for the line of business; in response to determining that the one or more insurance coverages do not satisfy the one or more required insurance coverages, outputting an identification of one or more missing insurance coverages or one or more attributes of an insurance coverage that render the insurance coverage insufficient for a corresponding required insurance coverage; and in response to determining that the one or more insurance coverages satisfy the one or more required insurance coverages, outputting a notification of compliance with the one or more required insurance coverages.

### BRIEF DESCRIPTION OF THE DRAWINGS

The present disclosure is further described in the detailed description which follows, in reference to the noted plurality of drawings by way of non-limiting examples of exemplary embodiments, in which like reference numerals represent similar parts throughout the several views of the drawings, and wherein:

FIG. 1 shows a block diagram of a parsing system with which some embodiments may operate.

FIG. 2 shows an illustrative flowchart of a method for analyzing a contract according to some embodiments.

FIG. 3 shows an illustrative flowchart of a method for generating reports related to a contract according to some embodiments.

FIG. 4 shows a block diagram of a computer-based system and platform within which some embodiments may be implemented.

FIG. 5 is a block diagram of a computer system with which some embodiments may operate.

While the above-identified drawings set forth some presently disclosed embodiments, other embodiments are also contemplated, as noted in the discussion below. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

Described herein are techniques that may be implemented by a computerized system for analyzing unstructured text to generate structured data from the analysis and determining whether a party is compliant with obligations described by the text based on an analysis of the structured data. In some implementations, determining whether a party is compliant can include analyzing the structured data by comparing the structured data generated from the unstructured text to other structured data retrieved from a data store. In some implementations, determining whether a party is compliant can include analyzing the structured data using a compliance prediction facility as described herein. The techniques described herein also enable the outputting, by the computerized system, of an identification of omitted or insufficient items in the unstructured text that relate to any such non-compliance. More particularly, described herein are techniques for generating and outputting a certificate of insurance identifying that a party to a contract holds insurance in a manner that is compliant with the contract.

A parsing system as described herein may parse insurance contracts using natural language understanding and/or textual analytics rules and determine whether a party to a contract is compliant with insurance coverage identified by the contract. Some techniques described herein can create structured data from unstructured contract text describing insurance coverage that a party to a contract is required to hold. Some such techniques include comparing the structured data indicating required coverages (which was determined from the unstructured text) to other structured data indicating coverages held by a party, to determine whether the coverage held by the party satisfies the required coverages. Other such techniques include analyzing the unstructured text and/or structured text using the compliance prediction facility and generating a prediction related to whether the coverage held by the party satisfies the required coverages. In some embodiments, a system implementing these techniques may output an indication whether coverage is missing or otherwise insufficient, or whether the coverages held by a party satisfy required coverages of the contract.

As noted herein, contracts (including agreements, permits, or other contracts) often contain insurance clauses or requirements. One or more parties to the contract, as well as other parties, may have an obligation to procure and maintain insurance to be compliant with the contract, and the contracts may specifically define insurance requirements of the parties such as what type of insurance is required and what amount of coverage.

Parties to contracts are also often called on to produce evidence of coverage, to demonstrate compliance with a contract's terms. Other entities that are not parties to the contract (e.g., an unrelated third party, or an insurance company or broker, or other entity) are usually relied on in this circumstance to produce “certificates of insurance.” In some such cases, the entity may assert with the certificate of insurance that they have reviewed the contract's terms and a party's insurance policies and have determined as an independent arbiter that the party is compliant with the contract's insurance requirements.

Production of certificates of insurance has been a manual process and continues to be a manual process to this day. Skilled reviewers of contracts, who specialize in reviewing of insurance language and generation of certificates of insurance, review contract terms and review information regarding insurance policies, and generate certificates of insurance based on their analysis.

The industry acknowledges that the certificate of insurance process is rife with error. Companies that specialize in the generation of such certificates, customers that seek out such certificates, and recipients of such certificates all understand that a very large number of the certificates of insurance are simply wrong. The companies that generate the certificates are regularly found liable for erroneous certificates. The total damages in the industry for erroneous certificates of insurance is on the order of hundreds of millions or billions of dollars and has been for decades.

The inventors have recognized and appreciated that there is a flaw in the current approach to certificates of insurance, but also recognize that the current erroneous system persists because of the lack of viable alternatives. The contracts are already reviewed closely by skilled practitioners who specialize in the review of this kind of insurance language. Obtaining reviewers who are even more skilled or more specialized is not feasible or practical and would not address fundamental difficulties in this industry.

The inventors have recognized and appreciated that human error on the part of the skilled reviewers is not the sole difficulty underlying the unreliable nature of the manual process. The human error is caused by, and compounded by, the complexity, variability, and subtlety of insurance language in contracts, as well as in insurance policies held by the parties to the contract. The inventors have recognized that language by which insurance coverage is described in insurance clauses of contracts is short but laden with meaning. Minor differences in wording or punctuation may have weighty differences in meaning of language. And such differences in wording or punctuation arise regularly. Contract language is not necessarily standardized but instead may be written anew each time by the parties and/or attorneys involved in the contract and may be made even more unique during negotiations over the contract terms and language.

As a result, two insurance paragraphs might look similar, but coverage might be very different because of the meaning with which slight variability in word choice or issues such as comma placement is imbued. As another example, identical contract language may have different meanings when the identities of or natures of the parties are different. As one such example, insurance language in two different contracts may refer to an “additional insured party” using identical language. However, if in one of the contracts the insured party is a company and the party to be made an additional insured is a municipality, the identical language will have very different meanings with regard to the insurance obligations imposed on the named insured party (the party to the contract) with respect to additional insured party (the municipality) as compared to identical language in a different contract situation in which both the party to the contract/named insured party and the additional insured party are companies. In the case that a contract specifies that a municipality is to be named as an additional insured party, compliance with the contract language may require specific insurance policy terms that may be different than are needed for other additional insured parties (e.g., companies).

There may even be further differences depending on the activity underlying the contract including the insurance language. For example, for a situation in which a state or governmental agency, subdivision, or political subdivision issued a permit or authorization for a construction project for an unrelated third party which requires additional insured status in favor of the state or governmental agency, subdivision, or political subdivision, a compliant insurance policy may need to include a standardized form such as “ISO Form CG 2012.” However, if the permit was issued for operations performed for that state or governmental agency or subdivision or political subdivision, then another type of standardized form such as “ISO Form CG 2010” for ongoing operations and possibly “ISO Form CG 2037” for completed operations would contain the appropriate additional insured language (e.g., policy endorsement) to be included in a compliant policy.

These additional endorsements would not be identified in the contract's insurance language nor in the policy text. An additional insured party may not be explicitly identified in contract text as a municipality, government agency, or subdivision, either, and an additional insured party may not be a party to the contract or in privity with the parties to the contract being analyzed and thus may not be identified in contract text with a high degree of particularity. These differences in meaning of insurance contract language are often left implicit and need to be understood by those who work in the field, rather than being explicitly set out in the contract text. This lack of explicit identification of differences in meaning between similar or even identical contract language hampers review but needs to be accounted for if a reliable conclusion is to be drawn of whether a party to a contract is compliant with their insurance obligations as set out in the contract.

There are still other examples of situations in which insurance language may have a variety of similarities between two contracts or language that is identical in whole or in part, but where the meaning of that insurance language is vastly different when the overarching subject matter or industry of the contract to which the insurance language relates is different. Such language that has identical or similar text but different meanings presents hurdles to review and determination of whether an insurance policy held by a party to a contract is compliant with the terms of the contract.

Contract review to determine the types of insurance coverages set out by a contract has thus been a difficult and manual process for some time and is widely recognized in the industry as being error prone. Some attempts to automate the process have led to computer-based techniques for analyzing and interpreting contracts to identify parties, lines of business, and other contract elements. Such attempts consistently fail to identify relevant elements and often produce unintelligible results. Moreover, such attempts are often cost and computing resource intensive as the techniques require continuous user input to provide feedback to the computer.

Natural language understanding (also sometimes known as natural language processing) engines have been created that seek to extract meaning from text. Such NLU tools analyze the lexical and grammatical structure of language looking for known common patterns. Each such known pattern is associated with a concept and when a known pattern is encountered in text, that concept is determined to be present in the text.

Insurance language in contracts has not been susceptible to interpretation using conventional NLU tools. As mentioned above, there is vast variability in insurance language of contracts, even between insurance language that is meant to convey identical concepts. This has impeded identification of the types of common text patterns on which the NLU tools rely. The analysis of insurance language with NLU is made even more difficult by the subtlety of meaningful textual changes, such as small changes like differences in punctuation that may cause similar language to have substantially different meaning. A further complicating factor is that, as mentioned above, even similar-appearing insurance contract language may have very different meanings when the overall subject matter of the contract is considered. The inventors have recognized and appreciated that each of these factors, and more, has impeded identification of textual patterns and impeded development of a reliable tool for parsing insurance language to identify required coverages. This has left the error-prone manual approach by specialized reviewers as the only mechanism for generating certificates of insurance, despite the significant sums owed in damages for incorrect certificates of insurance.

Described below are techniques for operating automated tools to parse language of insurance terms of contracts to determine what insurance coverages a party to the contract is required to hold, as identified by language of the contract. Techniques described herein can parse language of a contract to detect insurance clauses within the contract, such as by identifying clauses of the contract containing insurance verbiage. Such language of the contract may be or include text, which may include unstructured text such as prose text. Unstructured text may, in some cases, include lists or tables including text. Unstructured text may be differentiated from structured data, where for structured data specific pieces of data are held in a structure that defines a place for each such data to be held, and the place for a piece of data defines the data held, such as by defining a meaning of the data, or type of the data (numbers, decimals, integers, text, Boolean values, etc.), an amount or length of the data, and/or other aspects defining the data. Some techniques may then conduct a detailed review of that insurance verbiage to identify the contract terms defined by that insurance verbiage.

For example, the automated review of the contract language may identify multiple different insurance coverages specified within an insurance clause and then identify, for each coverage, a line of business (e.g., coverage type) to which each coverage relates and attributes of the coverage required for that line of business, such as a total amount of liability coverage, whether the liability coverage is individual or in the aggregate, whether a policy is required to identify other parties as additional insured parties and (if so) which parties, or other attributes.

The automated review may be performed using a combination of natural language understanding and rules in some embodiments, with the combination enabling a detailed review of the contract language and a more accurate analysis of the contract verbiage than has been previously possible. In some embodiments, insurance policies held by one or more parties to the contract may also be analyzed, and information extracted from an insurance policy may be used in interpretation of the contract text, and information extracted from the contract text may be used in interpretation of text or terms from the insurance policy.

For example, in some implementations, after extracting or otherwise obtaining structured data from unstructured text, a first rules-based analysis can be performed to identify contract elements (e.g., parties, insured entities, lines of business, policy limits or monetary amounts, or other contract clauses). Then, an NLU-based analysis may be performed on the contract elements to determine a context for one or more identified elements. Context with respect to a primary contract element may in some cases include other clauses or secondary contract elements that describe, characterize, or otherwise qualify the primary contract element.

In some embodiments, the automated review of unstructured contract text relating to insurance coverages may yield structured data identifying required insurance coverages laid out by the contract terms, where a party is required to hold the coverages to be compliant with the contract. In some such embodiments, a system for analyzing such contract language may additionally determine whether the party to the contract holds insurance coverages that are sufficient to meet the terms of the contract. To do so, the system may additionally retrieve structured data indicating insurance coverages held by the party, such as by retrieving the structured data from a data store or using an interface (e.g., an application programming interface or other interface) to an insurance data system to obtain data describing the insurance coverages held by the party. Such an insurance data system may be an agency management system (AMS) in some cases, a policy management system (PMS) in others, both an AMS and PMS in other cases, or other insurance data systems in other cases. In some embodiments, information on insurance coverages held by a party may be determined from a copy of a policy for the party, such as from structured and/or unstructured data defining a policy. The structured or unstructured data may be extracted from a document outlining the policy, such as from a structured form and/or unstructured text document that identifies terms of a policy.

The system may then compare data obtained from the contract language to data obtained about insurance coverages. For example, the system may analyze the structured data (obtained from analysis of the contract) indicating required insurance coverages and the structured data (obtained from the insurance system) indicating the insurance coverages held by the party, to identify a required insurance coverage that aligns with an insurance coverage held by the party. Once an alignment is determined, the system may determine whether the insurance coverage is sufficient to meet the corresponding requirements, such as by determining whether individual attributes of the held insurance coverage are sufficient to meet the required attributes (e.g., whether an amount of covered liability is sufficient). The system may in some cases perform this analysis for each required insurance coverage determined from the contract and produce information indicating whether the insurance coverages held by the party are sufficient to meet the terms of the contract.

In some such embodiments, the system may generate a report indicating whether the party is in compliance with the contract. In some such cases where the party is in compliance with the contract, the system may output a certificate of insurance (e.g., an ACORD form) laying out the insurance coverages held by the party. Such a certificate of insurance may be an evidence of property insurance, a memorandum of insurance, a confirmation of coverage, an evidence of insurance coverage, or other report indicating an amount or sufficiency of insurance coverage. Embodiments are not limited to operating with any specific formatting of insurance report and may operate with a variety of formats of certificate of insurance. In some cases, in which such a report is generated, the report may be populated with information regarding insurance coverages held by the party that align with the requirements of the contract, such as by identifying attributes of each insurance coverage. In some embodiments, rather than a report, a notification of compliance may be output, another visual artifact may be output, or otherwise data indicating compliance with the contract may be generated and output. Output information may be output for display and may be displayed on the same device on which the information was determined or generated.

In a case in which the system finds a party not to be in compliance with the contract, the system may output an identification of how the party's insurance coverages are insufficient, such as missing insurance coverages or insurance coverages where one or more attributes of the coverage do not satisfy required attributes identified by the contract.

Various parsing systems may be employed to parse documents and text thereof, to compare structured data, and determine compliance with terms of a contract. Examples are described below, but it should be appreciated that embodiments are not limited to operating in accordance with these examples.

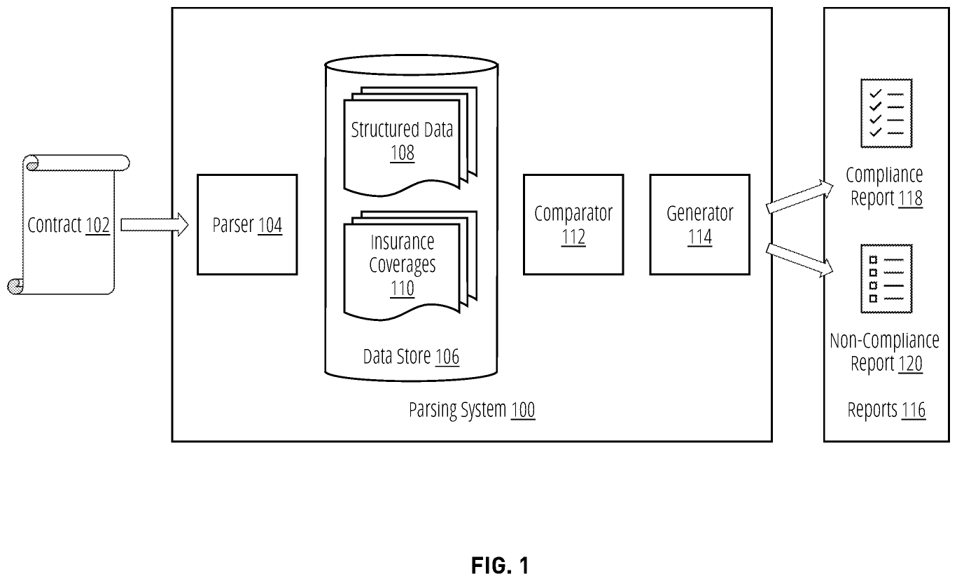

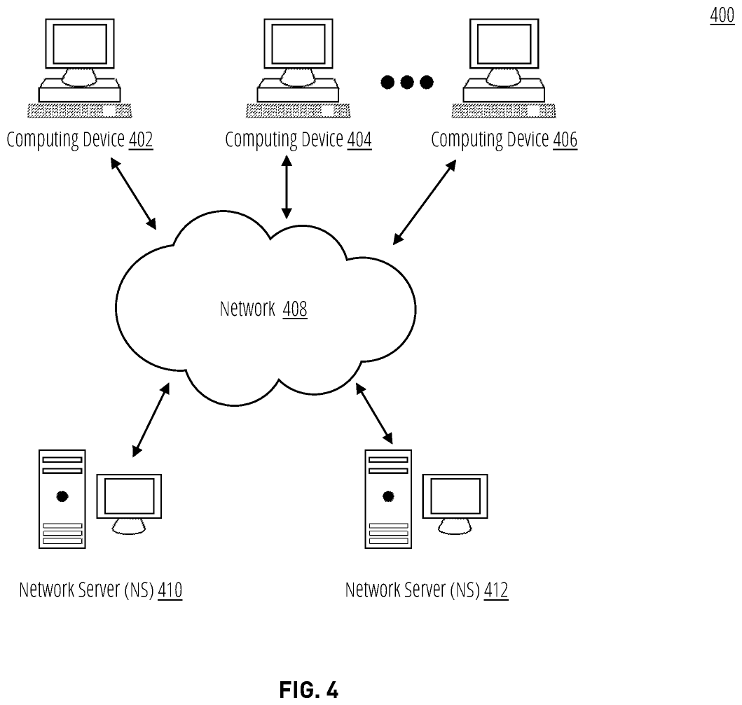

FIG. 1 depicts an embodiment of a parsing system 100 for parsing a contract 102 to generate report 116. Parsing system 100 can be implemented on one or more computing devices 402-406 or servers 410-412 described in relation to FIG. 4. That is, while parsing system 100 can be implemented within a single device, the disclosure is not so limited. In some cases, different components of parsing system 100 can be implemented on different interconnected devices (e.g., computing devices or servers) and each component can communicate with each other—directly and/or over any suitable network—to perform methods and operations described herein. In some embodiments, parser 104, comparator 112, and generator 114 may each be implemented as one or more software facilities, such as in executable instructions to be executed by one or more computing devices. While in some embodiments there are multiple facilities (e.g., parser 104, comparator 112, generator 114), in some other embodiments there may be a single facility performing functionality described herein, or any other arrangement of any number of facilities. Embodiments are not limited to any specific division of functionality between facilities. For ease of description, techniques are discussed herein in association with the example facilities illustrated in FIG. 1.

The contract 102 can be an agreement, image, or clause in any electronic format, such as in a portable document format (PDF). Contract 102 can be stored in the same device or server implementing parsing system 100 or it can be stored in a different device or server. The contract 102 can include unstructured text that describes the terms of the contract, which may include terms related to insurance and may include terms unrelated to insurance.

In a case in which the contract 102 is ingested by parsing system 100 in a format not containing text (e.g., an image of the contract), the parsing system 100 can be configured to generate text corresponding to characters included in the format. For example, the parsing system 100 can be configured to perform an optical character recognition (OCR) technique on the contract 102 to obtain text contained in the contract 102.

The parsing system 100 can include a parser 104. The parser 104 can receive or ingest text of the contract 102. The parser 104 may analyze the text of the contract 102 using techniques described herein, including to identify clauses or contract elements of the contract 102 that relate to insurance coverages and to analyze that text to identify required insurance coverages described by the text. In some embodiments, parser 104 can analyze structured data obtained in a preprocessing operation prior to being received by parser 104. In some embodiments, parser 104 can receive the unstructured text from contract 102, obtain the structured data, and perform further analysis on the structured data.

The parsing system 100 can include a data store 106 for storing structured data 108 that the parser 104 creates from the unstructured text of the contract 102 or otherwise receives in connection with contract 102. For example, the structured data 108 can be data describing each of the insurance requirements contained in the insurance text of a contract. For example, the structured data 108 can contain required insurance coverages 110, which can include a list, table, database or other data store of information for each required insurance coverage determined from the contract language. Such information may include a Line of Business (LOB) for the required coverage, limits of liability or property limits, coverage requirements, insurance policy endorsements, or other attributes. In some implementations, structured data 108, insurance coverages 110, and/or other contract elements can be associated to each other (e.g., by unique identifiers). Embodiments are not limited to operating with any particular attributes or other information regarding insurance coverages, as embodiments may operate with a variety of types of insurance and coverages.

The parsing system 100 can include a comparator 112 to compare insurance coverage requirements from the contract 102 against the actual coverage held by an insured entity. In some embodiments, structured data 108 can be compared to insurance coverages 110 using one or more comparison methods such as comparing keys, values, or strings, determining spatial or temporal relations between contract elements, and/or performing statistical analysis of the structured data 108. The comparator 112 can determine based on a comparison whether a particular contract element represents compliance by an entity with respect, for example, to insurance coverage.

The data store 106 can include a generator 114 for generating report 116 to indicate whether the contract 102 satisfies its intended requirements. In some implementations, the generator can have a predetermined or standardized output form and can populate fields within the standardized form based on the output of the comparator 112. For example, the report 116 can be generated in JSON and/or in an ACORD supported format populated with template data that indicates compliance of the contract 102. In some implementations, if the comparator 112 determines non-compliance in whatever form, comparator 112 can indicate the nature of the non-compliance to the generator 114 and the generator 114 can generate a report 116 indicating the nature of the non-compliance.

While in some embodiments, reports 116 can be a document for human consumption, in other embodiments, reports 116 can be a digital artifact or computer-readable file. For example, in some embodiments, reports 116 can be generated in a JavaScript Object Notation (JSON) format to be interpreted by other devices.

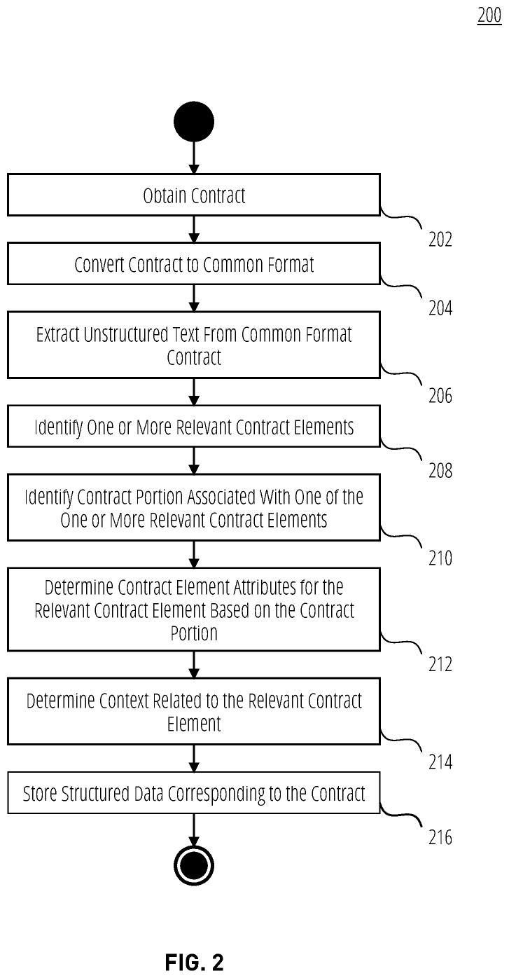

FIG. 2 illustrates a method 200 for analyzing a contract 102 using a parsing system 100. The method 200 may be performed by one or a combination of software facilities, such as the facilities illustrated in FIG. 1.

In Step 202, method 200 can include parser 104 receiving or otherwise obtaining contract 102. In some embodiments, parser 104 can receive contract 102 over a network from a different device than a device implementing parser 104. For example, a user of a first computing device such as devices 402-406 or servers 410-412 as described in relation to FIG. 4, can transmit the contract 102 over a network such as network 408, to a second device or server that implementing the parser 104 (e.g., executes the parser 104). The user may transmit contract 102 as part of a request to the device or server to analyze the contract 102. However, it should be appreciated that embodiments are not limited to parser 104 receiving the contract 102 over a network. In some cases, contract 102 can be directly uploaded by the user to the device implementing parser 104. In Step 202, parser 104 can also obtain contract 102 from another device or database directly, or over a network by transmitting a request to provide the contract 102 and receiving the contract 102 in response. Parser 104 can obtain contract 102 as a result of an input or request by a user to parser 104 to obtain or fetch contract 102.

Contract 102 can be received by parser 104 in any suitable format, as embodiments are not limited in this respect. Example formats include an image, email, document scan, text format (including text copied and pasted into a text interface), Microsoft Word document or DOCX format, XML format, comma separated value (CSV) document, or any other format.

In Step 204, method 200 can include converting or transforming contract 102 into a common or portable format to generate a common format contract 102. For example, a common format can be the Portable Document Format (PDF). Thus, in Step 204, method 200 can include converting contract 102 to PDF. If contract 102 is received already in a common format, then method 200 continues to Step 206.

While converting to a common format can preserve any text included in the received contract 102, in some cases, the contract 102 can be received in a non-text format such as an image or a flattened PDF. In those cases, in Step 206, method 200 can include performing optical character recognition on the common format contract 102 to extract any text reflected therein. The extracted text can be referred to as unstructured text (e.g., text that can be analyzed). For example, the parser 104 can create unstructured text from images or other non-text data in the contract 102. Through OCR, the parser 104 can create a set of words and punctuation for the contract 102 along with coordinates, page, paragraph, and sentence locations necessary to determine lexical and semantic context of the contract 102. In some cases, converting the contract 102 into a common format in Step 204 can include automatically performing OCR on the contract 102 to extract the unstructured text. In those cases, it can be said that Steps 204 and 206 are combined into a single step.

In Step 208, method 200 can include identifying one or more contract elements. While the following steps of method 200 will be described with respect to a single contract element, the disclosure is not so limited and method 200 can detect multiple contract elements in contract 102 and perform the following step with respect to each contract element detected.

Contract elements may include constituent parts of the contract, such as definitional parts of the contract like parties to the contract or term of the contract, or passages of the contract, or particular terms or clauses within the contract. A contract element can be a party to contract 102, insured entities identified in contract 102, lines of business (LOBs) covered or otherwise identified by contract 102, policy limits or monetary amounts (which can be related to LOBs and/or associated with one or more parties or one or more insured entities), dates or terms associated with any of the foregoing, or other contract clauses contained in contract 102, whether related to insurance or not. Thus, a contract element can be said to have a contract element type (e.g., party, LOB, amount, etc.) In some cases, contract elements can be associated with other contract elements. For example, a party may be associated with an LOB, an amount of coverage for that LOB, and/or a term during which the party is covered. Some contract elements may additionally be associated with characteristics of a contract element. For example, a contract element that is a party or other entity identified in the insurance language may be associated with characteristics that identify or describe the party/entity, such as a name of the entity, a type of the entity (individual or organization, or commercial entity, nonprofit or nongovernmental entity, government entity (e.g., municipality, state or province, country, government department or agency)), role the entity is to play in insurance for an LOB (insurance holder, additional insured, etc.), industry in which the entity operates and/or role the entity is to play in a task or project that is the subject of insurance language (e.g., engineer, architect, surveyor), or other information describing the entity. Such information characterizing the entity, such as identifying or describing the entity, may be extracted from text, such as text in the contract (in the insurance language or in other parts of the language) regarding the entity and/or what the entity is to do under the contract. As should be appreciated from the discussion herein, in some cases analysis of insurance language or compliance of insurance with insurance language may be linked to a type of an entity, such as in a case that different insurance rules apply for commercial organizations than for government entities such as municipalities. Proper analysis of insurance language may thus be linked to a type of an entity (e.g., party or other entity) identified in the insurance language, as different attributes of a LOB or otherwise different information may be extracted and analyzed for different entity types.

Parser 104 can analyze the unstructured text to identify the contract elements. In some cases, to identify the contract elements, parser 104 can implement a rules-based technique where the unstructured text is assessed with respect to known or predetermined rules. The predetermined rules can be a set of individual rules or a hierarchical structure of if-then rules (e.g., a decision tree). For example, the parser 104 can search the unstructured text based on a rule for identifying insurance requirements language. In this example, the parser 104 can implement a rule to identify all LOB s referenced in contract 102. If any unstructured text matches the desired language, then parser 104 can identify the unstructured text as a contract element and store the contract element as structured data (e.g., structured data 108). In some embodiments, the rules-based technique can include identifying regular expressions (e.g., a sequence of characters, otherwise known as “regex”) in the unstructured text and matching the identified regex with known regex associated with a potential contract element.

In some embodiments, as part of identifying contract elements, parser 104 may identify contract elements that satisfy one or more criteria for being related to insurance language or analysis of insurance language. In some such embodiments, parser 104 may identify all contract elements, then store information for later analysis only for those contract elements that satisfy the one or more criteria. In other embodiments, parser 104 may only identify contract elements and only store information regarding contract elements that satisfy the one or more criteria. Any suitable criteria may be used in some embodiments to determine whether elements are related to insurance portions of a contract or insurance language. In some examples described below, criteria relate to whether a contract element impacts insurance terms in a contract, and identified contract elements that satisfy criteria may be labeled “relevant” contract elements.

Parser 104 can associate one or more identified contract elements with the location of the contract element in the contract 102 for later recall. In the example above, where a relevant target contract element is an LOB, a set of rules for identifying contract elements can include identifying, for example, a string of text such as “automobile coverage” or “errors and omissions.” After parser 104 has identified the relevant contract element it can store the contract element and its location in the contract 102 in data store 106 (e.g., as part of structured data 108).

In some embodiments, when implementing a hierarchical rule structure, parser 104 can identify a contract element by finding a first target term (e.g., a party name, or type of LOB, level of coverage) using a keyword search and then perform a grammatical structure analysis (e.g., by pattern matching) of the text surrounding the target text to determine whether the target term is a relevant contract element. In some embodiments, parser 104 can determine a relevant contract element by comparing strings of text from contract 102 to a pattern associated with a type of contract element (e.g., a party, an LOB) and when a match is found the parser 104 can identify the relevant contract element as well as the type of contract element. For example, parser 104 may identify language to “E&O Liability,” “Errors and Omissions Liability,” or “Professional Indemnity” and associate such language with a “Professional Liability” LOB.

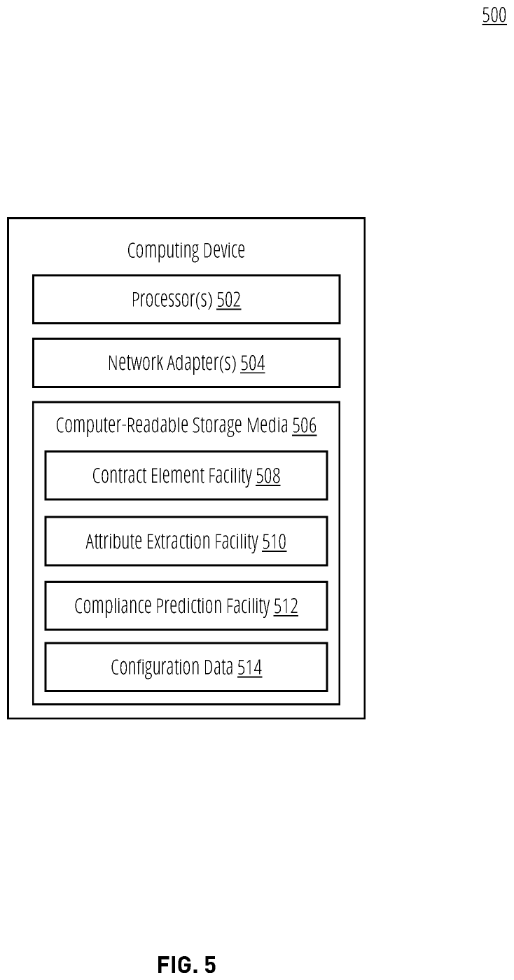

In some cases, parser 104 can perform a series of lexical scans over the text using natural language understanding to identify portions of the unstructured text that contain relevant contract elements. In some cases, parser 104 can use a functional facility such as contract element facility 508 discussed in FIG. 5 to implement a natural language understanding engine trained to identify contract elements and attributes thereof.

In Step 210, method 200 can include determining a contract portion of contract 102 associated with the relevant contract elements identified in Step 208. A contract portion can be a subset of text of a contract 102. In some embodiments, a contract portion can be a sequence of text related to a specific contract element (e.g., a party, an insured entity, a line of business (LOBs), a date, and the like). In some embodiments, parser 104 can identify a contract portion by selecting the text in contract 102 that spans a number of terms or words surrounding the relevant contract element. For example, a contract portion can expand a number of terms before (N₁) and a number of terms after (N₂) the relevant contract element (e.g., five terms before and five terms after; or ten terms after).

In another example, parser 104 can identify the contract portion by selecting a subset of text of contract 102 spanning a grammatically or syntactically logical portion of contract 102. In some cases, a contract portion can be a paragraph, a set of paragraphs, text following a heading or subheading and preceding another heading or subheading, a sentence, or a clause within a sentence. In some cases, the contract portion can be the text within two relevant contract elements, the text starting at the relevant contract element (or N₁ terms before) and ending at a numerical value (or N₂ terms after). In some implementations, parser 104 can store the relevant contract element, its position in contract 102, and/or the associated contract portion as structured data (e.g., structured data 108).

In Step 212, method 200 can include determining contract element attributes corresponding to the relevant contract elements based on the identified contract portion. Contract element attributes can define the scope of insurance coverage for a given LOB. That is, contract element attributes can be other contract elements associated with or that otherwise characterize a primary contract element. For example, for an LOB contract element, attributes can include one or more parties, one or more amounts of coverage, a term of coverage, and the like. For a contract element that is a party, attributes of the contract element may include characteristics of the party, such as characteristics identifying or describing the party (e.g., a type of party).

As another example, in Step 212, the parser 104 can determine a plurality of required insurance coverages (e.g., contract elements) in contract 102. For each required insurance coverage of the required insurance coverages, parser 104 can determine an LOB to which the required insurance coverage relates and it can determine further attributes of the required insurance coverage for the LOB. As yet another example, in some embodiments, parser 104 can analyze the unstructured text associated with an insurance specific language such as types of insurance and/or LOBs in Steps 208 and 210 and, in Step 212 determine attributes of insurance coverage such as limits, amounts of insurance, the type(s) of parties/entities identified within the insurance language and how those define or affect the required insurance coverage, and attributes such as whether a limit is on individual or aggregate liabilities related to the types of insurance and/or LOBs. As another example, parser 104 can identify an LOB such as “auto liability” and, based on a predetermined associated structure to that specific LOB, search for specific symbols within the text. For example, if a contract with an auto liability LOB requires coverage of “Owned/Non-Owned & Hired Auto” the predetermined associated structure should contain “SYMBOL 1” or “SYMBOLS 2 or 7, plus 8, and 9” to be compliant.

In some embodiments, to determine the contract element attributes, parser 104 can analyze the contract portion (e.g., in the form of unstructured text) of contract 102 using a natural language understanding engine trained to identify required insurance coverages, and/or one or more rules that define key words, phrases, or sets of words or phrases that are used in text representing certain insurance clauses. As noted with respect to Step 208-212, each rule, and/or each configuration setting of a natural language understanding engine (e.g., one or more concepts reflected in an ontology with which the engine is configured), may relate to an insurance concept (or contract element) to be extracted from text. In some cases, one or more rules and the natural language understanding engine may be used together to extract an insurance concept or contract element from text, such as by using a rule to identify text that may contain an insurance concept and then using natural language understanding to review that text and/or surrounding text (e.g., text within a threshold number of characters, words, or phrases, or text in the same clause or between delimiters such as periods of semicolons, or text that a semantic interpretation engine indicates is related or that grammatical structure indicates is related, or other way of identifying a section of text). The rules and the engine may thus be used together by a parser 104 to identify insurance language, given that (as discussed above) insurance language seldom follows standard patterns and identical language may have different meanings between contracts.

In some cases, the parser 104 can use the natural language understanding engine to search LOB s in matched insurance clauses or contract portions for individual insurance coverages or other attributes. The system may, in some embodiments, be configured with known attributes for each LOB that may appear in insurance language of a contract. When contract elements are identified and a contract element is an LOB, a set of attributes may be identified for that LOB, which are to be determined from the text of the contract element.

In some cases, the set of attributes for an LOB may be identified not only on the LOB, but also on other contract elements that set the context for the LOB. Such other contract elements may include party/entity contract elements, which may indicate other parties/entities to which the LOB relates (e.g., that are to hold the insurance, be an additional insured on the insured's policy, be a type of additional insured on the policy (e.g., for ongoing operations or completed operations), etc.). In some cases, the set of attributes may be identified based at least in part on attributes of a party contract element, such as information identifying or describing a party/entity. Such information identifying or describing a party/entity may be information indicating a type of the party/entity, a role the party/entity is to perform under the agreement or an industry in which the entity operates (e.g., engineer, architect, surveyor), or other information regarding a party/entity.

Within each LOB or coverage type, the parser 104 can use the natural language understanding engine to identify the required clauses, necessary coverage modifications, or insurance policy endorsements associated with that line of business (e.g., attributes of a contract element), such as to identify each attribute of the set of attributes known for that LOB, or known for a combination of LOB and entity type, or other combination of contract elements and/or attributes of contract elements. The parser 104 can use the natural language understanding engine for scans that use sets of rules that match against common phrases or patterns found in insurance language. These rules are extensible and in some embodiments the natural language understanding engine can be trained to greater levels of accuracy over time.

In some embodiments, the natural language understanding engine can be implemented in an attribute extraction facility 510 as discussed in relation to FIG. 5. An attribute extraction facility 510 can implement one or more suitable machine learning techniques for performing natural language understanding. The attribute extraction facility 510 can be trained based on known syntactic and grammatic language patterns for known contract elements. For example, an “automobile casualty” LOB may have as attributes an insured party, an amount indicating a policy limit, and a term. To identify the attributes, the attribute extraction facility 510 can be trained in patterns including “automobile liability” and corresponding parties, amounts, and terms.

In some embodiments, the natural language engine implemented by the attribute extraction facility 510 can be a transformer-based generative model such as GPT. In those embodiments, the attribute extraction facility 510 can be trained to recognize contract elements and associated attributes by providing the attribute extraction facility 510 with natural language inputs describing or providing example of the grammatical or syntactical structure of a contract portion corresponding to a specific contract element and associated attributes.

In Step 214, method 200 can include determining context related to the identified contract element and/or the associated attributes. Context related to a contract element can be used to interpret or otherwise provide semantic nuance to the contract element. In some embodiments, context can be determined from the contract portion associated with the contract element and the rest of the unstructured text of contract 102. Once identified context may then be used to inform an analysis of contract text, such as by analyzing contract text in light of a concept determined to be set out in the policy text. In some embodiments, the parser 104 may also be configured to analyze policy text in light of information extracted from the contract text, such as by determining that a contract text may have multiple meanings and then analyzing a policy text for whether one of the meanings is present.

The following provide non-limiting examples of Steps 208-214. As one example of a technique for analyzing insurance text, the parser 104 can analyze a contract 102 that applies to the automobile liability LOB:
Contract 102: automobile liability insurance and shall be written on an occurrence basis the county official employees and others as may be specified in any special conditions shall be named as an additional insured under this policy c automobile liability symbol 1 any auto or if contractor has no owned autos symbol 8 hired and 9 non owned with a combined single limit of 1000000 per accident for bodily injury and property damage.

In some cases, contracts 102 including auto liability insurance policies can use SYMBOLS to reference the various types of liability coverage. In this example, the parser 104 can determine the correct symbol type using a set of natural language rules. The following are example natural language rules to determine symbol types:

### Rules:

matchMnemonic: ‘Symbol 1—Any Auto’, matchMnemonic: ‘Symbol 1—Any Auto’,
   verbiage: ‘Symbol (1|one)’,
   verbiage: ‘any (auto|autos|automobile|automobiles|vehicle|vehicles)’,
matchMnemonic: ‘Symbol 2—Owned Autos’,
   verbiage: ‘Symbol (2|two)’,
   verbiage: ‘!no (owned|owns)*(auto|autos|automobile|automobiles|vehicle|vehicles)’,
   verbiage(auto|autos|automobile|automobiles|vehicle|vehicles)*(owned|owns)′,
   verbiage: ‘(owned|owners) form’,
matchMnemonic: ‘Symbol 7—Scheduled Autos’,
   verbiage: ‘Symbol (7|seven)’,
   verbiage:
   (scheduled|sched|lease|leased)*(auto|autos|automobile|automobiles|vehicle|vehicles)′,
   ‘(auto|autos|automobile|automobiles|vehicle|vehicles)*(scheduled|schedllease|leased)’,
matchMnemonic: ‘Symbol 8—Hired Autos’,
   verbiage: ‘Symbol (8|eight)’,
   verbiage:
   ‘(hired|hires|rented|rents)*(auto|autos|automobile|automobiles|vehicle|vehicles)’, verbiage:
   ‘(auto|autos|automobile|automobiles|vehicle|vehicles)*(hired|hires|rented|rents)’,
matchMnemonic: ‘Symbol 9—Non-owned Autos’,
   verbiage: ‘Symbol (9|nine)’,
   verbiage:
   ‘(nonowned|non-owned|non owned)*
(auto|autos|automobile|automobiles|vehicle|vehicles)’,
   verbiage: ‘(9|nine) (nonowned|non-owned|non owned)’,
   verbiage:
      ‘(auto|autos|automobile|automobiles|vehicle|vehicles)*(nonowned|non-owned|non owned|nonownership)’,
   verbiage: ‘(nonowned|nonowners) form’,
In an embodiment, where the natural language engine is implemented by the attribute extraction facility 510, the natural language engine can be trained to determine symbol types using a training prompt. For example, the following rule includes a training prompt directed towards an “auto liability” for a natural language engine:

Rules:

```
  mnemonic: ‘Auto Liability’,
  prompt:
    ‘Determine which types of vehicles need to be covered and then
based on that determine which Auto Liability symbols (1-9) should be
used. If there is a specific symbol that applies to a category of vehicle,
use only that symbol instead of the generic symbol. If the required
symbols are conditional, specify the condition in which the symbols are
required.’,
  responseStructure: {
    SYMBOL_1_ANY_AUTO: ‘boolean’,
    SYMBOL_2_OWNED_AUTO: ‘boolean’,
    SYMBOL_7_SCHEDULED_AUTO: ‘boolean’,
  SYMBOL_8_HIRED_AUTO: ‘boolean’,
    SYMBOL_9_NON_OWNED_AUTO: ‘boolean’,
      },
```

As another example, in some embodiments, the parser 104 can analyze parts of the contract 102 using a natural language understanding engine trained to identify a rule that identifies structure of text relating to a required insurance coverage to identify required insurance coverages that a party to the contract 102 is required to hold (e.g., attributes of a contract element). For example, the parser 104 can analyze a contract 102 that requires the ability to detect coverage limits that are not specified explicitly on a per limit basis:
Contract 102: Commercial General Liability insurance policy: vendor and subcontractors shall each maintain commercial general liability (CGL) insurance covering products and completed operations, personal injury, and contractual liability of not less than two million dollars. Commercial Umbrella insurance with a limit per each occurrence and with a general aggregate limit of $2,000,000.

Such a contract 102 can have language that indicates that both per occurrence and aggregate coverage have the same limit value. Each may be a contract element attribute. The parser 104 can apply rules that detect that only one numerical limit has been specified but needs to be applied to both (per/aggregate.) coverage limits to accurately populate the certificate. For example, shown below is the contract 102 that matches the contract language:

### Rule:

matchMnemonic: ‘Each Occurrence Limit,
verbiage:
   ‘commercial general liability*(per|each|one)*occurrence*aggregate*[<agg>#Value]’

As another example, where the natural language engine is implemented by the attribute extraction facility 510, a rule including a training prompt directed towards a “general liability aggregates” for a natural language engine can have the following form:

### Rules:

```
key: GENERAL_LIABILITY,
  mnemonic: ‘General Liability’,
  prompt: ‘If a limit number is not present, the value should be null’,
  responseStructure: {
    coverages: {
      limits: {
        PER_OCCURRENCE_LIMIT: ‘number’,
        DAMAGE_TO_RENTED_PREMISES: ‘number’,
        AGGREGATE: ‘number’,
        MEDICAL_EXPENSE: ‘number’,
        PERSONAL_AND_ADVERTISING: ‘number’,
        PRODUCTS_COMPLETED_OPERATIONS_AGGREGATE:
        ‘number’,
        },
      },
    }
```

As mentioned above, in some cases insurance language of a contract 102 may require an insured party (e.g., a contract element determined in Step 208) to hold a policy that identifies other entities as additional insured parties (e.g., attributes of the contract element). For example, a tenant's real estate lease may require the tenant to hold a Commercial General Liability (CGL) policy that makes a landlord, landlord's mortgagor, and landlord's property manager as “additional insured” parties to the CGL policy. In this case, the additional insured parties are themselves contract elements that can act as attributes for a CGL LOB contract element.

As described with respect to Step 216, the parser 104 may be configured to identify whether such an additional insured is required for a coverage and, if so, one or more attributes required for such an insurance coverage. Below are examples of three different analyses that may be done, to determine whether any of three different types of additional insured policies are present.

The “matchType: ‘single’” indicates that only one numerical limit will be present in contract text matching the rule. The first rule, for whether an additional insured is present, looks for language that mentions additional insured but not in the context of ongoing or completed operations. The second looks for additional insured requirements in the context of ongoing operations and discussions of commercial general liability and ISO endorsement CG 2010, a common insurance amendment. And the last looks for additional insured requirements in the context of completed operations and discussions of commercial general liability and ISO endorsement CG 20-37, another common insurance amendment.

Each rule and subcomponents of the rule can include additional terms to help configure the parser 104 implementing attribute extraction facility 510 to analyze the text. For example, “hasLimit” indicates whether a natural language engine of the parser 104 needs to find the identified text in the context of a value (typically numeric) indicating coverage limit and whether that coverage limit needs to be found. The related “limit” element indicates a default value for such a limit, and “limitModulo” indicates an acceptable minimum order of magnitude for such a limit value (for use in connection with other rules or text analysis scenarios that include such a limit) to identify values that are found but appear to be illogical values and thus may indicate a potentially erroneous match of the rule. The “associatedValues” element is usable in a rule to establish a selection of tags that the attribute extraction facility 510 will use to analyze text that the rule matches, in a post-processing analysis looking to extract additional information from the text.

The additional information may be extracted using natural language understanding, in some embodiments, and the tags may be used to configure such a natural language understanding engine to analyze the text matching the rule and/or surrounding text for specified information elements.

### Rule:

```
matchType: ′single′,
    matchMnemonic: ′Additional Insured′,
    policyField: ′addlInsd′,
    phrases: [
      {
        verbiage:
          ′(additional|additionally) (insured|insureds) * !ongoing *
          operations′,
        index: ″,
        hasLimit: false,
      },
      {
        verbiage:
          ′(additional|additionally) (insured|insureds) * !completed *
          operations′,
        index: ″,
        hasLimit: false,
      },
      {
        verbiage: ′included * (insured|insureds)′,
        index: ″,
        hasLimit: false,
      },
    ],
    limitModulo: 100000,
    hasLimit: false,
    limit: 0,
    associatedValues: [ ],
  },
  {
    matchType: ′single′,
    matchMnemonic: ′Additional Insured - Ongoing′,
    policyField: ′addlInsdBlktOngoing′,
    phrases: [
      {
        verbiage:
          ′(additional|additionally) (insured|insureds) * commercial
general liability * ongoing′,
        index: ″,
        hasLimit: false,
      },
      {
        verbiage:
          ′commercial general liability * (additional|additionally)
(insured|insureds) * ongoing′,
        index: ″,
        hasLimit: false,
      },
      {
        verbiage: ′(cg2010|cg 2010|cg 20 10)′,
        index: ″,
        hasLimit: false,
      },
    ],
    limitModulo: 100000,
    hasLimit: false,
    limit: 0,
    associatedValues: [ ],
  },
  {
    matchType: ′single′,
    matchMnemonic: ′Additional Insured - Completed′,
    policyField: ′addlInsdBlktOnComps′,
    phrases: [
      {
        verbiage:
          ′(additional|additionally) (insured|insureds) * commercial
general liability * completed′,
        index: ″,
        hasLimit: false,
      },
      {
        verbiage:
          ′commercial general liability * (additional|additionally)
(insured|insureds) * completed′,
        index: ″,
        hasLimit: false,
      },
      {
        verbiage: ′(cg2037|cg 2037|cg 20 37)′,
        index: ″,
        hasLimit: false,
      },
    ],
    limitModulo: 100000,
    hasLimit: false,
    limit: 0,
    associatedValues: [ ],
  },
```

In some embodiments, to distinguish between attributes in LOBs such as “commercial auto liability” (e.g., symbol values), the natural language engine implemented by the attribute extraction facility 510, can be trained using a rule including a training prompt in the following form:

### Rules:

```
  key: AUTO_LIABILITY,
  mnemonic: ‘Auto Liability’,
  prompt:
    ‘Determine which types of vehicles need to be covered and then
based on that determine which Auto Liability symbols (1-9) should be
used. If there is a specific symbol that applies to a category of vehicle,
use only that symbol instead of the generic symbol. If the required
symbols are conditional, specify the condition in which the symbols are
required.’,
  responseStructure: {
    coverages: {
      limits: {
        AUTO_MEDICAL_PAYMENTS_LIMIT: ‘number’,
        AUTO_MEDICAL_PAYMENTS_DEDUCTIBLE: ‘number’,
        BODILY_INJURY_PER_ACCIDENT: ‘number’,
        BODILY_INJURY_PER_PERSON: ‘number’,
        COLLISION_LIMIT: ‘number’,
        COLLISION_DEDUCTIBLE: ‘number’,
        COMBINED_PHYSICAL_DAMAGE_DEDUCTIBLE:
        ‘number’,
        COMBINED_PHYSICAL_DAMAGE_LIMIT: ‘number’,
        COMBINED_SINGLE_LIMIT: ‘number’,
        COMPREHENSIVE_DEDUCTIBLE: ‘number’,
        COMPREHENSIVE_LIMIT: ‘number’,
        LIABILITY_DEDUCTIBLE: ‘number’,
        PROPERTY_DAMAGE_DEDUCTIBLE: ‘number’,
        PROPERTY_DAMAGE_PER_ACCIDENT: ‘number’,
        TOWING_AND_LABOR: ‘number’,
      },
    },
    symbols: [
      {
        condition: ‘string’,
        symbols: [‘number’],
      },
    ],
    ADDITIONAL_INSUREDS: [‘string’],
    ADDITIONAL_INSURED: ‘boolean’,
    ADDITIONAL_INSURED_BLANKET: ‘boolean’,
    ADDITIONAL_INSURED_LESSOR: ‘boolean’,
    ‘30_DAY_NOTICE_OF_CANCELLATION’: ‘boolean’,
    ‘45_DAY_NOTICE_OF_CANCELLATION’: ‘boolean’,
    ‘60_DAY_NOTICE_OF_CANCELLATION’: ‘boolean’,
    ‘90_DAY_NOTICE_OF_CANCELLATION’: ‘boolean’,
    COMPREHENSIVE: ‘boolean’,
    HIRED_AUTO_PHYSICAL_DAMAGE: ‘boolean’,
    HIRED_AUTO_PROPERTY_DAMAGE: ‘boolean’,
    LENDERS_LOSS_PAYABLE: ‘boolean’,
    LOSS_PAYEE: ‘boolean’,
    LOSS_PAYEE_BLANKET: ‘boolean’,
    PRIMARY: ‘boolean’,
    NON_CONTRIBUTORY: ‘boolean’,
    TRUCKERS_UNIFORM_INTERMODAL_INTER-
CHANGE_ENDORSEMENT: ‘boolean’,
    WAIVER_OF_SUBROGATION_BLANKET: ‘boolean’,
    SYMBOL_1_ANY_AUTO: ‘boolean’,
    SYMBOL_2_OWNED_AUTO: ‘boolean’,
    SYMBOL_7_SCHEDULED_AUTO: ‘boolean’,
    SYMBOL_8_HIRED_AUTO: ‘boolean’,
    SYMBOL_9_NON_OWNED_AUTO: ‘boolean’,
    },
  },
```

In Step 216, method 200 can include storing structured data 108 related to the contract 102. The parser 104 can create structured data 108 after analyzing the unstructured text of the contract 102 in Steps 208-214. The parser 104 can generate a list or table, or other data store, of insurance requirements identified by the contract language of contract 102 including relevant contract elements, contract portions, associated contract element attributes, and related context.

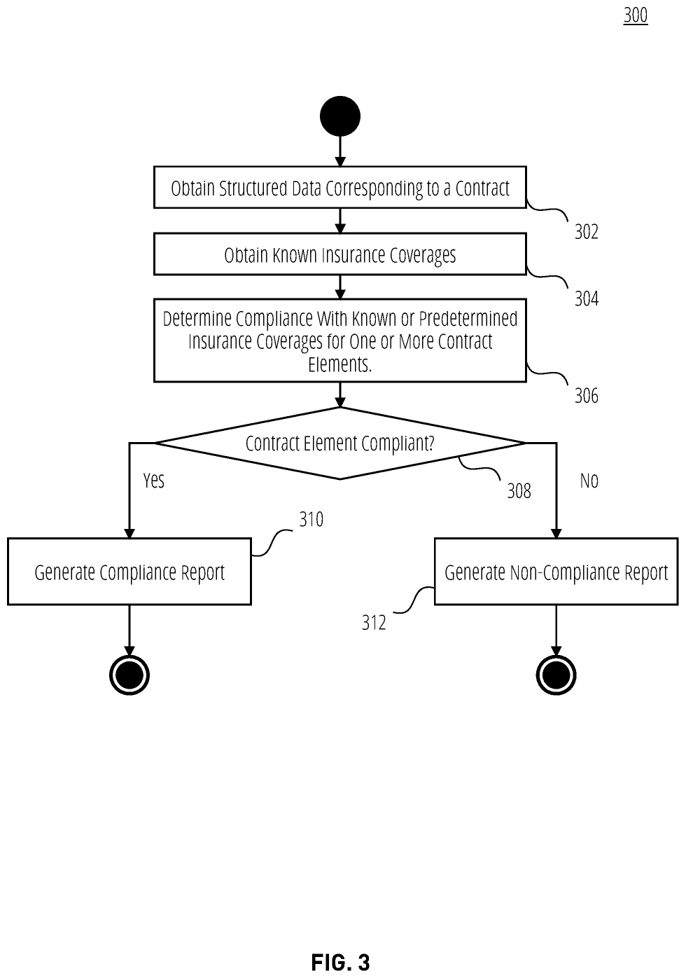

FIG. 3 shows an illustrative flowchart of a method 300 for generating report 116 related to a contract 102 according to some embodiments. As noted, parsing system 100 can generate report 116 to indicate compliance (or non-compliance) of the insurance coverage provided in a contract 102 with predetermined or known insurance requirements. For example, through method 300, comparator 112 can match or otherwise compare identified LOB s and the corresponding attributes (e.g., coverages within the contract 102 for each LOB) with predetermined insurance coverage a party to contract 102 is supposed to have and generate or export a resulting list of requirements complied with and/or to be met by the party.

In Step 302, method 300 can include comparator 112 obtaining structured data 108 associated with contract 102 from data store 106. Structured data 108 can include one or more contract elements corresponding to contract 102 representing insurance coverage provided in the contract 102. The structured data 108 can be the structured data created as part of the analysis performed through method 200 on contract 102 described with respect to FIG. 2. In some cases, structured data 108 can include contract elements, contract portions associated with the contract elements, contract element attributes corresponding to the contract elements, and/or context related to the contract elements stored as an associated set as part of structured data 108 in data store 106. In some embodiments, the comparator 112 can retrieve, from the data store 106, the structured data 108 indicating insurance coverages identified for a party to the contract 102. The structured data 108 can identify, for each insurance coverage of the insurance coverages, a line of business to which the insurance coverage relates and attributes of the insurance coverage.

In Step 304, method 300 can include obtaining known or predetermined insurance coverages. Comparator 112 can obtain the known or predetermined insurance coverages 110 from data store 106. Comparator 112 can access the data store 106 to retrieve the required insurance coverages 110. Insurance coverages 110 can include levels of insurance coverage for different LOBs. In some cases, insurance coverages 110 can be used to determine compliance with insurance requirements of the insurance coverages contained within contract 102.

In Step 306, method 300 can include determining compliance of the contract 102 with the known or predetermined insurance coverages 110. Comparator 112 can compare insurance coverage requirements (e.g., insurance coverages 110) against the actual coverage held by an insured entity (e.g., contract elements, attributes, contract portions, and context in structured data 108, identified in FIG. 2). In some embodiments, the comparator 112 can determine whether the insurance coverages identified for the party satisfy the required insurance coverages 110 that the party to the insurance contract is required to hold. The required insurance coverages 110 can include a list, table, or database of LOB, limits of liability or property limits, and coverage requirements, or insurance policy endorsements. Comparator 112 can compare the required insurance coverages 110 with the structured data 108 that identifies the coverages contained in the contract 102. In some embodiments, the comparator 112 can compare the required insurance coverages 110 with structured data 108 stored in an agency management system or other data storage system.

In some embodiments, comparator 112 can determine that an insurance coverage for an LOB included in the structured data 108 (e.g., indicating insurance coverages identified for the party), has a corresponding required insurance coverages 110 for said LOB. For example, comparator 112 can determine that an insurance coverage for the automobile liability LOB has a limit that is required for that type of LOB. The comparator 112 can compare required attributes of the insurance coverage in the structured data 108 to attributes of the required insurance coverages 110 for said LOB. That is, continuing with the example above, the comparator 112 can compare the coverage limit in the structured data 108 to the required coverage limit in the required insurance coverages 110.

In some embodiments, comparator 112 can identify mismatches between the required insurance coverages 110 (e.g., table or database of insurance requirements) and those contained in the structured data 108 (e.g., contract 102 for policy, agency management system, or from other data storage system). Comparator 112 can determine if the coverage held by the insured entity according to the required insurance coverages 110 is compliant with the contract requirements set out in the structured data 108 of the contract 102. The comparator 112 can identify or flag mismatches as insufficient coverage to indicate that the contract requirements are not yet met. For example, the contract 102, as written, may not satisfy the coverage requirements and should be revised.

In Step 308, method 300 determines whether to continue to Step 310 to generate a compliance report 118 or to Step 312 to generate a non-compliance report 120 based on whether one or more contract elements of contract 102 (e.g., insurance coverage provided in contract 102) is non-compliant with insurance coverages 110.

In Step 310, method 300 can include generating compliance report 118 of report 116 based on whether all contract elements in contract 102 are compliant with insurance coverages 110. In some embodiments, the generator 114 can generate reports 116 to indicate whether the contract 102 satisfies its intended requirements. For example, a report 116 can be based on an ACORD form populated with data that indicates compliance of the contract 102. In some embodiments, the data for populating contract 102 can include contract elements, attributes, and context determined using method 200. For example, the generator 114 can populate an ACORD form or other evidence or memorandum of insurance when the data in the table or database of insurance coverages 110 matches those contained on the structured data 108 associated with the contract 102 from the policy, agency management system, or other data storage system.

In some embodiments, the report may be populated with data obtained from the contract 102 (e.g., structured data 108), data obtained from an insurance system (e.g., AMS and/or PMS), or data obtained from another source. The data may be inserted into the report in the same manner in which it was obtained from or generated by the source of the data. In other embodiments, the data may be inserted into template language or a template format, and the templated data may be inserted into the compliance report 118. Embodiments are not limited to populating reports in any particular manner. In some embodiments, as mentioned above, rather than outputting a report or certificate, embodiments may output an identification of compliance or a notification of compliance, which may include any suitable data indicating compliance with the terms of the contract.

In some embodiments, the generator 114, in response to determining that the structured data 108 indicating insurance coverages satisfy the required insurance coverages 110, can output a compliance report 118 that includes a notification of compliance with the required insurance coverages 110. For example, the generator 114 can populate an evidence of coverage document indicating the insured entity has the required coverages as evidenced in the original contract 102. In some embodiments, the generator 114 can output compliance report 118 that includes a document for the contract originator (which may or may not be the insuring party) to use as proof coverage by the insured entity.

In response to determining that the insurance coverages identified in the structured data 108 do not satisfy the required insurance coverages 110 in Step 306 and 308, in Step 312, method 300 can include generating a non-compliance report 120. Generator 114 can output a non-compliance report 120 of reports 116 that includes an identification of the missing insurance coverages or the attributes of an insurance coverage that render the insurance coverage in the structured data 108 insufficient for a corresponding required insurance coverages 110. In some embodiments, rather than a report, the system may output a notification of noncompliance or another identification of noncompliant (e.g., missing or insufficient) insurance coverages.

FIG. 4 shows a block diagram of a computer-based system and platform within which some embodiments may be implemented. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 400 can be configured to manage a large number of members and concurrent transactions, as detailed herein. In some embodiments, the exemplary computer-based system and platform 400 can be based on a scalable computer and network architecture that incorporates various strategies for assessing the data, caching, searching, and/or database connection pooling. An example of the scalable architecture is an architecture that is capable of operating multiple servers.

In some embodiments, referring to FIG. 4, member computing device 402, member computing device 404 through member computing device 406 (e.g., clients) of the exemplary computer-based system and platform 400 can include virtually any computing device capable of receiving and sending a message over a network (e.g., cloud network), such as network 408, to and from another computing device, such as servers 410 and 412, each other, and the like. In some embodiments, the member devices 402-406 can be personal computers, multiprocessor systems, microprocessor-based or programmable consumer electronics, network PCs, and the like.

In some embodiments, one or more member devices within member devices 402-406 can include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 402-406 can be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, Bluetooth, ZigBee, etc.).

In some embodiments, one or more member devices within member devices 402-406 can run one or more applications, such as Internet browsers, mobile applications, voice calls, video games, videoconferencing, and email, among others. In some embodiments, one or more member devices within member devices 402-406 can be configured to receive and to send web pages, and the like. In some embodiments, an exemplary specifically programmed browser application of the present disclosure can be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like.

In some embodiments, a member device within member devices 402-406 can be specifically programmed by either Java, .Net, QT, C, C++ and/or other suitable programming language. In some embodiments, one or more member devices within member devices 402-406 can be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network s 408 can provide network access, data transport and/or other services to any computing device coupled to it. In some embodiments, the exemplary network 408 can include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 408 can implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 408 can include and implement, as an alternative or in conjunction with one or more of the above, a WiMAX architecture defined by the WiMAX forum. In some embodiments and, optionally, in combination of any embodiment described above or below, the exemplary network 408 can also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 408 can be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 408 can also include mass storage, such as network attached storage (NAS), a storage area network (SAN), a content delivery network (CDN) or other forms of computer or machine-readable media.

In some embodiments, the exemplary server 410 or the exemplary server 412 can be a web server (or a series of servers) running a network operating system, examples of which may include but are not limited to Microsoft Windows Server, Novell NetWare, or Linux. In some embodiments, the exemplary server 410 or the exemplary server 412 can be used for and/or provide cloud and/or network computing. Although not shown in FIG. 4, in some embodiments, the exemplary server 410 or the exemplary server 412 can have connections to external systems like email, SMS messaging, text messaging, ad content providers, etc. Any of the features of the exemplary server 410 can also be implemented in the exemplary server 412 and vice versa.

In some embodiments, one or more of the exemplary servers 410 and 412 can be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 402-406.

In some embodiments and, optionally, in combination of any embodiment described above or below, for example, one or more exemplary computing member devices 402-406, the exemplary server 410, and/or the exemplary server 412 can include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

Techniques operating according to the principles described herein may be implemented in any suitable manner. Included in the discussion above are a series of flow charts showing the steps and acts of various processes that generate structured data from unstructured text and determine whether the structured data is consistent with other structured data, including to determine whether an entity is compliant with insurance obligations. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of Steps and/or acts described in each flow chart is merely illustrative of the algorithms that may be implemented and can be varied in implementations and embodiments of the principles described herein. Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 506 of FIG. 5 described below (i.e., as a portion of a computing device 500) or as a stand-alone, separate storage medium.

As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) (e.g., device 402-406, server 410-412) operating in any suitable computer system, including the exemplary computer system of FIG. 4 (e.g., platform 400), or one or more computing devices (or one or more processors of one or more computing devices) may be programmed to execute the computer-executable instructions.

A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing devices (co-located or geographically distributed) dedicated to executing the techniques described herein, one or more Field-Programmable Gate Arrays (FPGAs) for carrying out the techniques described herein, or any other suitable system.

FIG. 5 illustrates one exemplary implementation of a computing device in the form of a computing device 500 that may be used in a system implementing techniques described herein, although others are possible. It should be appreciated that FIG. 5 is intended neither to be a depiction of necessary components for a computing device in accordance with the principles described herein, nor a comprehensive depiction.

Computing device 500 may comprise at least one processor 502, a network adapter 504, and computer-readable storage media 506. Computing device 500 may be, for example, a server, including a web server, a server of a content delivery network (CDN), including of a point of presence (POP) of a CDN, a server of a cloud computing network or data center, or other suitable server. As another example, computing device 500 may be a desktop or laptop personal computer, a personal digital assistant (PDA), a smart mobile phone, or any other suitable computing device. Network adapter 504 may be any suitable hardware and/or software to enable the computing device 500 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable storage media 506 may be adapted to store data to be processed and/or instructions to be executed by processor 502. Processor 502 enables processing of data and execution of instructions. The data and instructions may be stored on the computer-readable storage media 506.

The data and instructions stored on computer-readable storage media 506 may comprise computer-executable instructions implementing techniques which operate according to the principles described herein. In the example of FIG. 5, computer-readable storage media 506 stores computer-executable instructions implementing various facilities and storing various information as described above. Computer-readable storage media 506 may store a contract element facility 508, an attribute extraction facility 510, a compliance prediction facility 512, and a configuration data 514 that includes configuration information for one or more of the facilities, including the natural language understanding. These facilities may carry out one or more of the techniques discussed above.

While not illustrated in FIG. 5, a computing device 500 may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It will be understood that various changes may be made in the function and arrangement of elements without departing from the spirit and scope of the presently disclosed embodiments. Embodiment examples are described as follows with reference to the figures. Identical, similar, or identically acting elements in the various figures are identified with identical reference numbers and a repeated description of these elements is omitted in part to avoid redundancies.

From the foregoing description, it will be apparent that variations and modifications may be made to the embodiments of the present disclosure to adopt it to various usages and conditions. Such embodiments are also within the scope of the following claims.

The recitation of a listing of elements in any definition of a variable herein includes definitions of that variable as any single element or combination (or sub-combination) of listed elements. The recitation of an embodiment herein includes that embodiment as any single embodiment or in combination with any other embodiments or portions thereof

What is claimed is:

1. A method comprising:
obtaining a contract including unstructured text;
determining a contract element contained in the contract by analyzing the unstructured text;
identifying a contract portion from the unstructured text, the contract portion associated with the contract element;
extracting at least one contract element attribute related to the contract element by analyzing the contract portion using an attribute extraction facility; and
generating a report related to the contract based on determining whether the at least one contract element attribute of the contract element matches at least one predetermined contract element attribute.

2. The method of claim 1, further comprising analyzing the unstructured text includes by applying at least one rule to the unstructured text to identify known contract elements.

3. The method of claim 1, further comprising determining a position of the contract element in the unstructured text and identifying the contract portion based on the position of the contract element.

4. The method of claim 3, wherein the contract portion includes a subset of the unstructured text, and wherein the subset is determined by selecting an N₁ number of terms before and an N₂ number of terms after the position of the contract element in the unstructured text.

5. The method of claim 3, wherein the contract portion includes a subset of the unstructured text, and wherein the subset is determined by selecting a grammatically or syntactically logical portion of the unstructured text related to the contract element.

6. The method of claim 1, wherein the attribute extraction facility includes a natural language understanding engine trained to identify syntactical or grammatical structures in the unstructured text corresponding to discrete contract elements.

7. The method of claim 1, further comprising determining that the at least one contract element attribute matches the at least one predetermined contract element attribute and generating the report as a compliance report indicating that the contract satisfies an insurance coverage requirement.

8. The method of claim 7, wherein generating the compliance report includes populating template fields in an ACORD supported format.

9. The method of claim 1, further comprising determining that the at least one contract element attribute does not match the at least one predetermined contract element attribute and generating the report as a non-compliance report identifying one or more of missing insurance coverages, insurance limits, and policy clauses or endorsements associated with the at least one contract element attribute.

10. At least one non-transitory computer-readable storage medium for storing instructions executable by a processor, the instructions comprising:
obtaining a contract including unstructured text;
determining a contract element contained in the contract by analyzing the unstructured text;
identifying a contract portion from the unstructured text, the contract portion associated with the contract element;
extracting at least one contract element attribute related to the contract element by analyzing the contract portion using an attribute extraction facility; and
generating a report related to the contract based on determining whether the at least one contract element attribute of the contract element matches at least one predetermined contract element attribute.

11. The at least one non-transitory computer-readable storage medium of claim 10, the instructions further comprising analyzing the unstructured text includes by applying at least one rule to the unstructured text to identify known contract elements.

12. The at least one non-transitory computer-readable storage medium of claim 10, the instructions further comprising determining a position of the contract element in the unstructured text and identifying the contract portion based on the position of the contract element.

13. The at least one non-transitory computer-readable storage medium of claim 12, wherein the contract portion includes a subset of the unstructured text, and wherein the subset is determined by selecting an N₁ number of terms before and an N₂ number of terms after the position of the contract element in the unstructured text.

14. The at least one non-transitory computer-readable storage medium of claim 12, wherein the contract portion includes a subset of the unstructured text, and wherein the subset is determined by selecting a grammatically or syntactically logical portion of the unstructured text related to the contract element.

15. The at least one non-transitory computer-readable storage medium of claim 10, wherein the attribute extraction facility includes a natural language understanding engine trained to identify syntactical or grammatical structures in the unstructured text corresponding to discrete contract elements.

16. The at least one non-transitory computer-readable storage medium of claim 10, the instructions further comprising determining that the at least one contract element attribute matches the at least one predetermined contract element attribute and generating the report as a compliance report indicating that the contract satisfies an insurance coverage requirements.

17. The at least one non-transitory computer-readable storage medium of claim 16, wherein generating the compliance report includes populating template fields in an ACORD supported format

18. The at least one non-transitory computer-readable storage medium of claim 10, the instructions further comprising determining that the at least one contract element attribute does not match the at least one predetermined contract element attribute and generating the report as a non-compliance report identifying one or more of missing insurance coverages, insurance limits, and/or policy clauses associated with the at least one contract element attribute.

19. A method comprising:
creating structured data from unstructured text of a contract, wherein creating the structured data comprises:
analyzing the unstructured text of the contract to identify one or more parts of the contract that address insurance a party to the contract is required to hold; and
analyzing the one or more parts of the contract using a natural language understanding engine trained to identify required insurance coverages and/or at least one rule identifying structure of text relating to a required insurance coverage to identify one or more required insurance coverages that the party to the contract is required to hold, wherein analyzing the one or more parts of the contract to identify the one or more required insurance coverages comprises determining from the unstructured text, for each required insurance coverage of the one or more required insurance coverages, a line of business to which the required insurance coverage relates and one or more attributes of the required insurance coverage for the line of business;
retrieving, from at least one data store, structured data indicating one or more insurance coverages identified for the party to the contract, the structured data identifying for each insurance coverage of the one or more insurance coverages a line of business to which the insurance coverage relates and one or more attributes of the insurance coverage;
determining whether the one or more insurance coverages identified for the party satisfy the one or more required insurance coverages that the party to the contract is required to hold, wherein determining whether the one or more insurance coverages satisfy the one or more required insurance coverages comprises
in response to determining that an insurance coverage for a line of business, of the one or more insurance coverages identified for the party, corresponds to a required insurance coverage for the line of business, comparing one or more required attributes of the required insurance coverage to one or more attributes of the insurance coverage for the line of business;
in response to determining that the one or more insurance coverages do not satisfy the one or more required insurance coverages, outputting an identification of one or more missing insurance coverages or one or more attributes of an insurance coverage that render the insurance coverage insufficient for a corresponding required insurance coverage; and
in response to determining that the one or more insurance coverages satisfy the one or more required insurance coverages, outputting a notification of compliance with the one or more required insurance coverages.

20. The method of claim 19, wherein determining from the unstructured text, for each required insurance coverage of the one or more required insurance coverages, a line of business to which the required insurance coverage relates and one or more attributes of the required insurance coverage for the line of business comprises:
analyzing the one or more parts of the contract using at least one rule to identify a first line of business to which first contract text relates; and
analyzing the first contract text for the first line of business using the natural language understanding engine to identify one or more first attributes of required insurance coverage for the first line of business.
